(19) United States
(12) Patent Application Publication
(10) Pub. No.: US 2006/0255173 A1
(43) Pub. Date: Nov. 16, 2006

(54) Fuel injection device device for a combustion engine

(76) Inventors: Peter Boehland, Marbach (DE); Sebastian Kanne, Schwaikheim (DE); Godehard Nentwig, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/567,571

(22) PCT Filed: Jun. 22, 2004
(86) PCT No.: PCT/DE04/01302

§ 371 Date: Feb. 8, 2006

(30) Foreign Application Priority Data
Aug. 8, 2003 (DE) 103 36 411.0

(51) Int. Cl. F02M 41/16

(52) U.S. Cl. 239/96; 239/585.1

(57) ABSTRACT

A fuel injection device for an internal combustion engine includes a first valve element with a pressure face acting in the opening direction. An actuating device acts in the closing direction. A second valve element has a hydraulic control face, acting in the closing direction, which defines a hydraulic control chamber. A corresponding actuating device acts in the opening direction. A high-pressure connection is provided. The fuel injection device includes an additional valve device, which in a first terminal position connects the pressure chamber only with the low-pressure connection and the control chamber only with the high-pressure connection. In a second terminal position, the additional valve device connects the pressure chamber only with the high-pressure connection and essentially disconnects the control chamber from the high-pressure connection. In an intermediate position, the pressure chamber communicates only with the high-pressure connection, and the control chamber communicates simultaneously with both the high-pressure connection and the low-pressure connection.

### PRIOR ART

The invention relates to a fuel injection device for an internal combustion engine, in particular with direct fuel injection, having at least two valve elements, of which one valve element has a pressure face acting in the opening direction, which defines a pressure chamber, and an actuating device acting in the closing direction, and of which another valve element has a hydraulic control face, acting in the closing direction, which defines a hydraulic control chamber that communicates at least from time to time with a high-pressure connection, and an actuating device acting in the opening direction, and having a control valve which can connect the control chamber with a low-pressure connection.

A fuel injection device of the type defined above is known from German Patent Disclosure DE 100 58 130 A1. This reference shows an injection nozzle for internal combustion engines, with two coaxially disposed and separately triggerable valve elements. The outer valve element is pressure-controlled; that is, as a result of an increase in an injection pressure that engages a pressure face acting in the opening direction, it lifts from its valve seat counter to a spring force and as a result uncovers corresponding outlet openings. The inner valve element is stroke-controlled. This means that it opens when the pressure of a hydraulic fluid in a control chamber is lowered. The force, acting in the opening direction, of the inner valve element is furnished by the injection pressure engaging a corresponding pressure face. For controlling the known fuel injection device, at least two pressure reservoirs with different pressure levels and at least two control valves are required.

The reasons for embodying fuel injection devices with a plurality of valve elements are as follows:

Particularly in diesel engines, to reduce emissions and enhance efficiency, it is necessary to inject the fuel into the appropriate combustion chambers of the engine in as finely atomized a form as possible. This can be done either by making the injection pressure at which the fuel reaches the fuel injection device high, or increasing the number of fuel outlet openings from which the fuel emerges from the fuel injection device into the combustion chamber and simultaneously reducing the individual cross section of a fuel outlet opening. These provisions make it possible to improve the atomization quality of the injected fuel streams while simultaneously reducing the droplet diameter of the fuel mist (spray) produced.

By using a plurality of valve elements, which each uncover a certain number of fuel outlet openings, good atomization quality can be attained, even if only a small fuel quantity is to be injected. When a large fuel quantity is to be injected, this need not be done at the cost of an excessively long injection duration and/or an excessively high injection pressure.

The object of the present invention is to refine a fuel injection device of the type defined at the outset such that it can be triggered as simply as possible yet still functions reliably. Simultaneously, in its use in the applicable internal combustion engine, good emissions and fuel consumption should be attainable.

These objects are attained in a fuel injection device of the type defined at the outset by providing that it includes an axial boundary face, which in a first terminal position connects the pressure chamber with only the low-pressure connection and connects the control chamber with the high-pressure connection, in a second terminal position connects the pressure chamber at least predominantly with the high-pressure connection and substantially disconnects at least one region of the control chamber from the high-pressure connection, and in an intermediate position connects the pressure chamber at least predominantly with the high-pressure connection and also connects the control chamber with the high-pressure connection.

### ADVANTAGES OF THE INVENTION

In the fuel injection device of the invention, only one high-pressure connection and one low-pressure connection are needed. A plurality of pressure reservoirs at different pressure levels can be dispensed with. The opening and closing of the valve elements can be triggered independently of one another.

In the first terminal position of the additional valve device, only a slight pressure prevails in the pressure chamber, and hence the first valve element can be pressed into the closing direction by the actuating device. In the control chamber at the same time, a high pressure prevails, by which the second valve element is also pressed into the closing direction.

In the second terminal position of the valve device, a high pressure prevails in the pressure chamber and at the pressure face brings about a corresponding hydraulic opening force, as a result of which the first valve element opens. Simultaneously, the hydraulic control chamber is essentially disconnected from the high-pressure connection and can therefore be made, via the control valve, to communicate solely with the low-pressure connection. The pressure in the control chamber therefore drops markedly and quickly, and the second valve element can be opened by the actuating device acting in the opening direction. In this second terminal position, both valve elements are accordingly open.

In the intermediate position provided according to the invention, the pressure chamber communicates with the high-pressure connection; thus a high pressure prevails in it, as a result of which the first valve element is opened. The control chamber conversely also communicates with the high-pressure connection. If it is now simultaneously made to communicate with the low-pressure connection via the control valve, then an “intermediate pressure” is established in the control chamber. The actuating device acting in the opening direction on the second valve element is designed such that even at this kind of intermediate pressure in the hydraulic control chamber, the second valve element still remains reliably closed. In this intermediate position of the valve device, thus only the first valve element is open.

This is all made possible finally only with the high-pressure and low-pressure connections that are already present in conventional devices, and hence the fuel injection device of the invention is inexpensive and simple in construction. Because of the pressure-controlled opening of the first valve element, a ramplike pressure increase while the second valve element is simultaneously closed is attained. Especially at low load of the engine, this leads to favorable emissions and fuel consumption. If conversely the valve device is immediately put in the second terminal position, both valve elements open very fast, which in full-load operation at high engine speed makes it possible to achieve a square-wave course of injection. As a result, the total injection duration at high rpm can be limited.

The triggering principle can be applied very simply in existing fuel injection devices as well, since no modifications in the valve elements themselves, for instance, are necessary. In the fuel injection device of the invention, the typical advantages of fuel injection devices with two valve elements are furthermore attained. This includes the fact that in pressure-load operation of the engine, for instance, small injection quantities at comparatively high pressure can also be attained. This is because whenever only the first valve element opens, only a few outlet openings are “active”, and longer injection times can therefore be realized. As a result, even with small quantities to be injected, good atomization, comparable to that in full-load operation, is achieved. This avoids hard combustion with severe noise buildup.

Furthermore, the requirements for precision in terms of maintaining a very short switching time when very small quantities are injected, as are involved in a preinjection, for instance, are also made less stringent. As a result, the variation in quantity from one injection to another can be lessened.

Advantageous refinements of the invention are defined by dependent claims.

First, it is proposed that the additional valve device has a cylindrical switch body that has a first valve edge, which disconnects the pressure chamber from the low-pressure connection; a second valve edge, which connects the pressure chamber with the high-pressure connection; and a hydraulic control face, which defines the hydraulic control chamber. The additional valve device in this case is accordingly a hydraulic servo valve. Such a valve is technically simple to make and functions reliably. There is no need for additional trigger lines.

It is especially advantageous if a fluid conduit which at least from time to time connects the high-pressure connection with the control chamber is embodied in the switch body. Such a fluid conduit can be drilled into the switch body in a simple way and reduces the metal-cutting machining work, which must be done for instance to a housing of the fuel injection device, to a minimum. In the end, this reduces production costs.

There can be a flow throttle restriction in the fluid conduit, or the fluid conduit can be embodied in its entirety as a flow throttle restriction. Such a flow throttle restriction is also known as an “inlet throttle restriction” or “I throttle restriction”. The pressure drop, pressure buildup, and also a level of the injection pressure, whenever the additional valve device is in its intermediate position, are varied by way of the dimensioning of the inlet throttle restriction. By this means, the overall switching behavior of the entire fuel injection device can be adjusted.

A refinement of the fuel injection device of the invention that is also very simple to produce is that in which there is a sealing portion at an axial boundary face of the control chamber, at which portion the switch body comes to rest in the second terminal position, and which in this second terminal position of the switch body disconnects a region of the control chamber, defined by the control face of the second valve element and connectable with the low-pressure connection, from a region of the control chamber that communicates with the fluid conduit. In this way, in the second terminal position of the switch body, the hydraulic pressure engaging the control face of the second valve element is lowered very quickly, since the inflow of fuel from the fluid conduit is severely throttled or even largely suppressed. Once the switch body has reached the second terminal position, the second valve element therefore opens at high speed, which favors the development of the desired square-wave course of injection. It is expressly pointed out here that the sealing portion may be present for instance equally well on the switch body itself or on a housing face diametrically opposite the switch body.

It may also be provided that the actuating device acting in the closing direction on the first valve element is designed such that the first valve element opens at a comparatively slight pressure at the high-pressure connection. In that case, a very gradual pressure rise is made possible when there is low pressure at the high-pressure connection, which can be the case at low load of the engine. Simultaneously, a steep pressure rise at high load is assured, when a high pressure is usually present at the high-pressure connection.

Finally, it is proposed that the switch body has a central through opening, in which one portion of the second valve element is guided. As a result, the dimensions of the fuel injection device of the invention are kept quite small.

### DRAWING

An especially preferred exemplary embodiment of the present invention is described in further detail below in conjunction with the accompanying drawings. Shown in the drawings are:

FIG. 1, a schematic illustration of a fuel system of an internal combustion engine, having a plurality of fuel injection devices;

FIG. 2, a fragmentary section through one of the fuel injection devices of FIG. 1;

FIG. 3, a detail III of the fuel injection device of FIG. 2;

FIG. 4, a detail IV of the fuel injection device of FIG. 2; and

FIG. 5, a graph in which the course of injection upon an actuation of the fuel injection device of FIG. 2 is plotted for various operating modes.

### DESCRIPTION OF THE EXEMPLARY EMBODIMENT

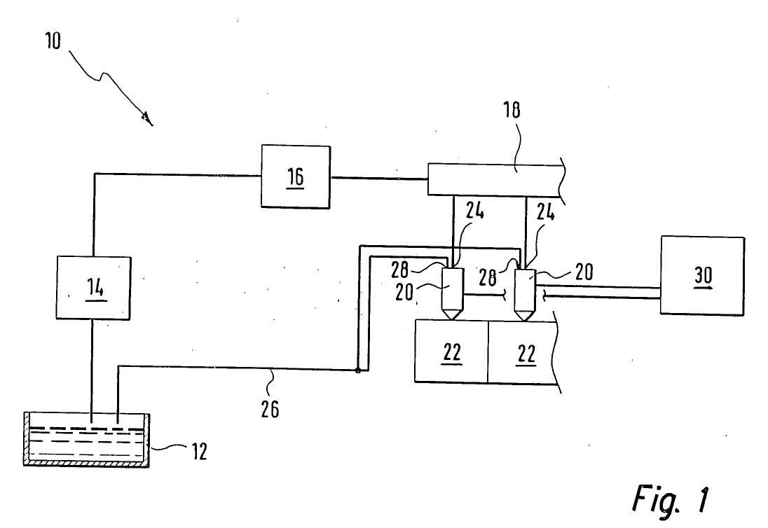

In FIG. 1, a fuel system of an internal combustion engine is identified overall by reference numeral 10. It includes a fuel tank 12, from which an electric fuel pump 14 pumps the fuel to a high-pressure pump 16. This latter pump pumps the fuel onward to a fuel collection line 18 (“rail”), in which the fuel is stored at very high pressure. A plurality of fuel injection devices 20 are connected to the rail 18 and inject the fuel directly into combustion chambers 22 associated with them.

The connection of the fuel injection devices 20 to the rail 18 is made via high-pressure connections 24. A low-pressure line 26 connects the fuel injection devices 20 with the fuel tank 12. To that end, low-pressure connections 28 are provided on the fuel injection devices 20. The operation of the fuel injection devices 20 is controlled and regulated by a control and regulating unit 30.

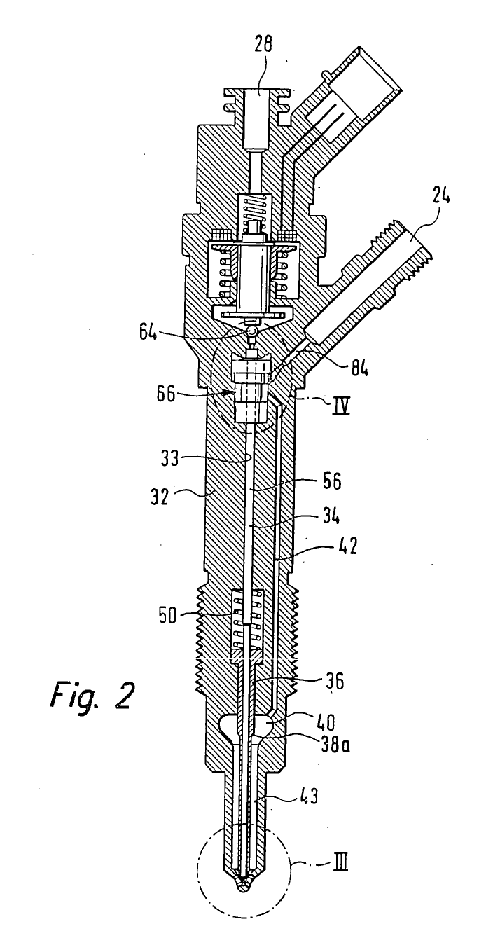

FIG. 2 shows a fuel injection device 20 in greater detail: It includes a housing 32, in which, in a stepped longitudinal bore 33, two valve elements 34 and 36 coaxial to one another are guided. The outer valve element 36 is pressure-controlled, and the inner valve element 34 is stroke-controlled.

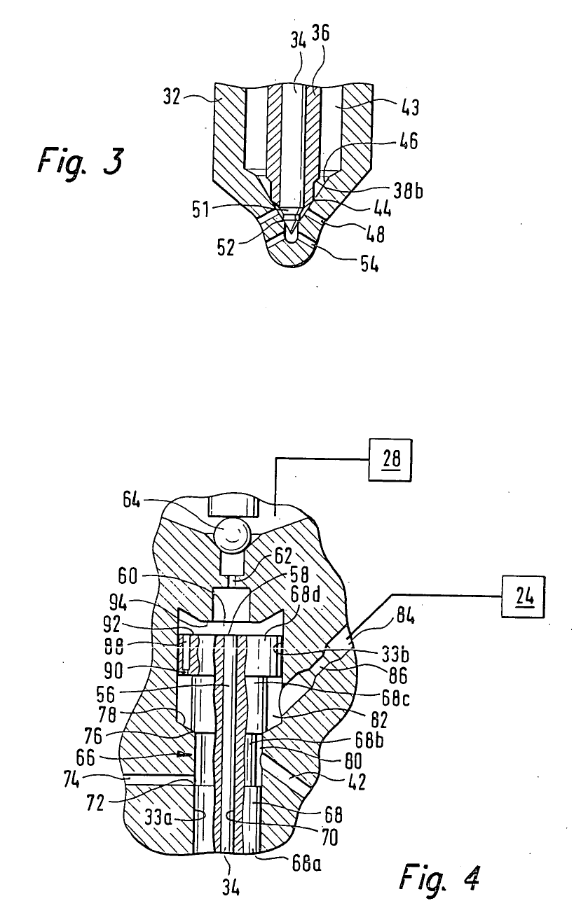

To that end, approximately halfway along its length, the outer valve element 36 has a pressure face 38, whose force resultant points in the opening direction. The pressure face 38 defines a pressure chamber 40, which as will be described in further detail hereinafter can be made to communicate, via a conduit 42, selectively with the low-pressure connection 28 or the high-pressure connection 24. An annular chamber 43 leads from the pressure chamber 40 to the lower end, in FIG. 2, and pointing in the installed position into the combustion chamber 22, of the fuel injection device 20; this is shown in detail in FIG. 3.

In FIG. 3, there is a further pressure face 38b on the outer valve element 36. A sealing edge 44 of the outer valve element 36 cooperates with a conical housing face 46. When the sealing edge 44 lifts from the housing face 46, fuel outlet conduits 48, which are distributed over the circumference of the fuel injection device 20, are made to communicate with the annular chamber 43. A compression spring 50 urges the outer valve element 36 into the closed position, in which the sealing edge 44 rests on the housing face 46.

The inner valve element 34 is guided in some regions in the outer valve element 36. On its lower end in terms of FIG. 2, it likewise has a pressure face 51 acting in the opening direction as well as a sealing edge 52, which in the closed state also rests on the housing face 46. The inner valve element 34 includes fuel outlet conduits 54, which are likewise distributed over the circumference of the fuel injection device 20. The inner valve element 34 has a thrust rod portion 56 (see FIG. 2), which has a somewhat larger diameter than the portion (not identified by reference numeral) where the sealing edge 52 is located.

The thrust rod portion 56 is bounded on its upper end in FIG. 2 (see also FIG. 4) by a hydraulic control face 58, which acts in the closing direction of the inner valve element 34. The hydraulic control face 58 defines a hydraulic control chamber 60. From the control chamber, an outlet throttle restriction 62 leads to an electromagnetic 2/2-way switching valve 64 (which can, however, also be designed as a piezoelectric valve). By way of it, the outlet throttle restriction 62 can be made to communicate with the low-pressure connection 28.

The opening and closing of the two valve elements 34 and 36 is influenced in the final analysis by an additional valve device 66, which is embodied as a hydraulic servo valve. Its construction will now be described in further detail, referring in particular to FIG. 4:

The servo valve 66 includes a cylindrical switch body 68. This switch body has a central through opening 70, through which the thrust rod portion 56 of the inner valve element 34 is passed. The switch body 68 has a total of four portions 68a, 68b, 68c, and 68d, which have different diameters. The two portions 68a and 68b are received in a portion 33a of the longitudinal bore 33, while conversely the two portions 68c and 68d are received in a portion 33b of the longitudinal bore. The portion 33b has a larger diameter than the portion 33a.

The outer diameter of the lowermost portion 68a, in terms of FIG. 4, of the switch body 68 has approximately the same diameter as the portion 33a of the longitudinal bore 33; the portion 68d of the switch body 68 has approximately the same diameter as the portion 33b of the longitudinal bore 33. These two portions are therefore guided in fluid-tight fashion in the longitudinal bore 33. The portion 68b of the switch body 68 has a smaller diameter than the portion 68a. The portion 68c has a larger diameter than the portion 68a, but a smaller diameter than the portion 68d.

In this way, a slide edge 72 is formed between the portions 68a and 68b of the switch body 68. By means of this slide edge, a conduit 74, which is in communication with the low-pressure connection 28, can be opened or closed. Between the portions 68b and 68c, a sealing edge 76 is formed, which cooperates with a slightly conical step 78 located between the portions 33a and 33b of the longitudinal bore 33. If the sealing edge 76 is resting on the step 78, then an annular chamber 80, which is present between the portion 68b of the switch body 68 and the portion 33a of the longitudinal bore 33, is disconnected from an annular chamber 82, which is present between the portion 68c of the switch body 68 and the portion 33b of the longitudinal bore 33. Conversely, if the sealing edge 76 has lifted from the step 78, then the two annular chambers 80 and 82 communicate with one another. The conduit 42 that originates at the pressure chamber 40 discharges into the portion 33a of the longitudinal bore 33, specifically axially above the orifice of the conduit 74 in terms of FIG. 4. From the annular chamber 82, a high-pressure conduit 84 in turn branches off and communicates with the low-pressure connection 24. In the high-pressure conduit 84, there is a throttle restriction 86.

In the portion 68d of the switch body 68, there is an axially extending fluid conduit 88, in which in turn an inlet throttle restriction 90 is embodied. The fluid conduit 88 connects the annular chamber 82 with the hydraulic control chamber 60. The annular end face, oriented toward the control chamber 60, of the switch body 68 forms a hydraulic control face 92. The boundary face (not identified by reference numeral) of the control chamber 60, on the housing and located diametrically opposite the control face 92 of the switch body 68, has an annular sealing portion 94. This sealing portion is located, in terms of the radial direction, between the orifice of the fluid conduit 88 into the control chamber 60 and the control face 58 of the inner valve element 34.

The fuel injection device 20 shown in FIGS. 2 through 4 functions as follows:

When the 2/2-way switching valve 64 is closed, the communication between the control chamber 60 and the low-pressure connection 28 is interrupted. Simultaneously, however, the control chamber 60 communicates with the high-pressure connection 24 via the high-pressure conduit 84, the annular chamber 82, and the fluid conduit 88. In the control chamber 60, a high fluid pressure therefore prevails. By means of the corresponding hydraulic force, acting in the closing direction on the hydraulic control face 58 of the inner valve element 34, the inner valve element 34 is pressed with the sealing edge 52 against the housing face 46.

By means of the hydraulic force also acting on the control face 92 of the switch body 68, the switch body is pressed with the sealing edge 76 against the step 78. In this position of the switch body 68, the slide edge 72 uncovers the conduit 74. Thus via the conduit 42 and the annular chamber 80, the pressure chamber 40 finally communicates with the low-pressure connection 28. The hydraulic forces acting on the pressure faces 38a and 38b are comparatively slight, and thus the outer valve element 36 is pressed with its sealing edge 44 against the housing face 46 by the compression spring 50. The outer valve element 36 is also therefore closed. No fuel is dispensed by the fuel injection device 20.

When the 2/2-way switching valve 64 is opened, the hydraulic control chamber 60 communicates with the low-pressure connection 28. As a result, the pressure in the control chamber 60 drops. Because of the high pressure prevailing the annular chamber 82 (which after all communicates constantly with the high-pressure connection 24 via the high-pressure conduit 84), the switch body 68 now lifts with its sealing edge 76 from the step 78. As a result, on the one hand, the slide edge 72 of the switch body 78 covers the orifice of the conduit 74, so that the annular chamber 80 is now disconnected from the low-pressure connection 28. Second, as a result, the two annular chambers 80 and 82 are made to communicate with one another, so that both in the annular chamber 80 and in the conduit 42 and the pressure chamber 40, as well as the annular chamber 43, a corresponding high fluid pressure builds up.

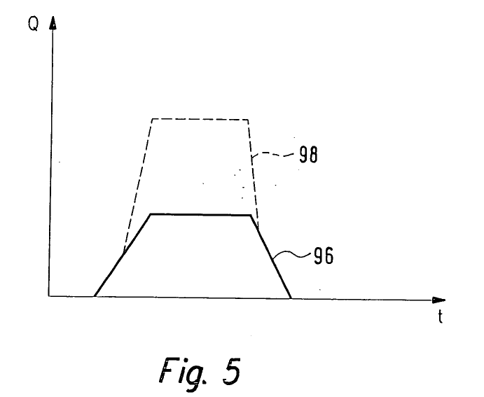

The hydraulic forces acting in the opening direction on the pressure faces 38a and 38b exceed the force exerted by the compression spring 50 in the closing direction, and thus the outer valve element 36 with its sealing edge 44 lifts from the housing face 46. Fuel is now dispensed through the outlet conduits 48. The result is the typical pressure course for pressure-controlled valve elements, which is shown at 96 in FIG. 5, with a ramplike pressure rise. The control chamber 60 overall continues to communicate with the high-pressure connection 24 via the fluid conduit 88. In the hydraulic control chamber 60, a still comparatively high intermediate pressure is therefore established, which prevents the inner valve element 34 from opening. Fuel is accordingly dispensed exclusively through the outlet conduits 48.

When the control face 92 of the switch body 68, in its “upper” terminal position, comes to rest on the sealing portion 94 of the housing, the communication between the region of the control chamber 60 located radially inward from the sealing portion 94 with the fluid conduit 88 and thus finally with the high-pressure connection 24 is largely or even completely interrupted. The pressure in this radially inner region of the control chamber 60 now drops further, which leads to a corresponding reduction in the hydraulic force acting in the closing direction on the control face 58 of the inner valve element 34.

Since the outer valve element 36, with its sealing edge 44, has lifted from the housing face 46, hydraulic forces acting in the opening direction are now exerted on the pressure face 51 of the inner valve element 34. These forces cause the inner valve element 34 now to open. Fuel can additionally emerge through the outlet conduits 54 as well. The result is a pressure course shown in dashed lines in FIG. 5 and identified by reference numeral 98.

For terminating the injection event, the 2/2-way switching valve 64 is closed again. As a result, the pressure in the control chamber 60 rises again. Because of the force acting on the control face 92 of the switch body 68, the switch body returns to its outset position, in which with its sealing edge 76 it rests on the step 78, and in which the slide edge 72 again uncovers the conduit 74. As a result, the pressure chamber 40 is disconnected from the high-pressure connection 24 and now communicates with the low-pressure connection 28, so that the pressure in the annular chamber 80 and consequently also in the conduit 42 and in the pressure chamber 40 drops.

The outer valve element 36 can therefore be pressed by the compression spring 50 back into the closed position, in which the sealing edge 44 rests on the housing face 46. As a result, the hydraulic force acting on the pressure face 51 of the inner valve element 34 drops, and simultaneously the hydraulic force acting on the control face 58 of the inner valve element 34 increases. Thus the inner valve element is pressed back into its closed position.

If in an injection only the outer valve element 36 is meant to be opened, the 2/2-way switching valve is closed again before the switch body 68, with its control face 92, comes into contact with the sealing portion 94. In that case, the control chamber 60 communicates simultaneously with the low-pressure connection 28 and, via the fluid conduit 88, with the high-pressure connection 24. Accordingly, in the control chamber 60, an “intermediate pressure” therefore results (possibly only very briefly), at which the switch body 68 does not open entirely, and the inner valve element 34 remains reliably closed. Although in a sense the pressure chamber 43 also communicates with the low-pressure connection 28 via the inlet throttle restriction 90, nevertheless the corresponding pressure drop in the pressure chamber 43 is so slight that it does not yet lead to closure of the outer valve element 36. The outer valve element 36 is not closed until the slide edge 72 uncovers the conduit 74 again.

A restoring spring for the inner valve element 34 can be dispensed with, since in normal operation this valve element is securely moved by the prevailing pressure forces. In addition, even if the 2/2-way switching valve 64 is defective, it is assured, regardless of the pressure in the rail 18, that no fuel will be injected, since the outer valve element 36 is closed by the compression spring 50 and thus also prevents the inflow to the fuel outlet conduits 54.

It will also be noted that the ramp of the pressure course (reference numeral 96 in FIG. 5), upon the opening of the outer valve element 36, is dependent on the pressure in the rail 18. At a high pressure in the rail 18, as is typically established at high load and high engine speed, a comparatively steep ramp can be realized; thus the outer valve element 36 opens correspondingly quickly. At low load and correspondingly low pressure in the rail 18, conversely, a comparatively low ramp is realized.

1-7. (canceled)

8. In a fuel injection device for an internal combustion engine with direct fuel injection, the injection device having at least two valve elements, of which one valve element has a pressure face acting in the opening direction, which defines a pressure chamber, and an actuating device acting in the closing direction, and of which another valve element has a hydraulic control face, acting in the closing direction, which defines a hydraulic control chamber that communicates at least from time to time with a high-pressure connection, and an actuating device acting in the opening direction, and having a control valve, which can connect the control chamber with a low-pressure connection, the improvement wherein the injector device comprising an additional valve device including an axial boundary face, which in a first terminal position connects the pressure chamber with only the low-pressure connection and connects the control chamber only with the high-pressure connection, in a second terminal position connects the pressure chamber at least predominantly with the high-pressure connection and substantially disconnects at least one region of the control chamber from the high-pressure connection, and in an intermediate position connects the pressure chamber at least predominantly with the high-pressure connection and also connects the control chamber with the high-pressure connection.

9. The fuel injection device as defined by claim 8, wherein the additional valve device comprise a cylindrical switch body that has a first valve edge which disconnects the pressure chamber from the low-pressure connection; a second valve edge which connects the pressure chamber with the high-pressure connection; and a hydraulic control face which defines the hydraulic control chamber.

10. The fuel injection device as defined by claim 9, further comprising a fluid conduit which at least from time to time connects the high-pressure connection with the control chamber is embodied in the switch body.

11. The fuel injection device as defined by claim 10, wherein the fluid conduit comprises a flow throttle restriction.

12. The fuel injection device as defined by claim 10, further comprising a sealing portion on an axial boundary face of the control chamber at which the switch body comes to rest in the second terminal position, and which in this second terminal position of the switch body disconnects a region of the control chamber defined by the control face of the second valve element and connectable with the low-pressure connection from a region of the control chamber that communicates with the fluid conduit.

13. The fuel injection device as defined by claim 11, further comprising a sealing portion on an axial boundary face of the control chamber at which the switch body comes to rest in the second terminal position, and which in this second terminal position of the switch body disconnects a region of the control chamber defined by the control face of the second valve element and connectable with the low-pressure connection from a region of the control chamber that communicates with the fluid conduit.

14. The fuel injection device as defined by claim 8, wherein the actuating device acting in the closing direction on the first valve element is designed such that the first valve element opens at a comparatively slight pressure at the high-pressure connection.

15. The fuel injection device as defined by claim 9, wherein the actuating device acting in the closing direction on the first valve element is designed such that the first valve element opens at a comparatively slight pressure at the high-pressure connection.

16. The fuel injection device as defined by claim 10, wherein the actuating device acting in the closing direction on the first valve element is designed such that the first valve element opens at a comparatively slight pressure at the high-pressure connection.

17. The fuel injection device as defined by claim 11, wherein the actuating device acting in the closing direction on the first valve element is designed such that the first valve element opens at a comparatively slight pressure at the high-pressure connection.

18. The fuel injection device as defined by claim 12, wherein the actuating device acting in the closing direction on the first valve element is designed such that the first valve element opens at a comparatively slight pressure at the high-pressure connection.

19. The fuel injection device as defined by claim 13, wherein the actuating device acting in the closing direction on the first valve element is designed such that the first valve element opens at a comparatively slight pressure at the high-pressure connection.

20. The fuel injection device as defined by claim 9, wherein the switch body comprises a central through opening, in which one portion of the second valve element is guided.

21. The fuel injection device as defined by claim 10, wherein the switch body comprises a central through opening, in which one portion of the second valve element is guided.

22. The fuel injection device as defined by claim 11, wherein the switch body comprises a central through opening, in which one portion of the second valve element is guided.

23. The fuel injection device as defined by claim 12, wherein the switch body comprises a central through opening, in which one portion of the second valve element is guided.

24. The fuel injection device as defined by claim 13, wherein the switch body comprises a central through opening, in which one portion of the second valve element is guided.

25. The fuel injection device as defined by claim 14, wherein the switch body comprises a central through opening, in which one portion of the second valve element is guided.

26. The fuel injection device as defined by claim 15, wherein the switch body comprises a central through opening, in which one portion of the second valve element is guided.

27. The fuel injection device as defined by claim 16, wherein the switch body comprises a central through opening, in which one portion of the second valve element is guided.
